(19) United States
(12) Patent Application Publication
(10) Pub. No.: US 2006/0088002 A1
(43) Pub. Date: Apr. 27, 2006

(54) Mobile equipment for providing a few of services at a same traffic channel

(76) Inventors: Nohee Park, Gyeonggiddo (KR); Wonjae Cha, Gyeonggido (KR)

Correspondence Address: BIRCH STEWART KOLASCH & BIRCH, PO BOX 747, FALLS CHURCH, VA, 22040-0747, US

(21) Appl. No.: 10/540,137

(22) PCT Filed: Feb. 5, 2004
(86) PCT No.: PCT/KR04/00214

§ 371 Date: Jun. 21, 2005

(30) Foreign Application Priority Data
Feb. 5, 2003 (KR) 10-2003-0001705

(51) Int. Cl. H04Q 7/00

(52) U.S. Cl. 370/329; 370/352; 370/535

(57) ABSTRACT

Provided is a mobile terminal used for a mobile communication system simultaneously providing multiple services through a wireless traffic channel by multiplexing/de-multiplexing the multiple services and a method thereof, and more particularly, to a mobile terminal used for a mobile communication system simultaneously providing multiple services through a wireless traffic channel by implementing an optimal wireless channel connection using voice vocoding transmission, variable rate voice coding vocoder in order to reduce interference. Accordingly, since multiple services are simultaneously transmitted or received, it is possible to easily provide value-added services.

### TECHNICAL FIELD

The present invention relates to a mobile terminal used for a mobile communication system simultaneously providing multiple services through a wireless traffic channel by multiplexing the multiple services and a method thereof, and more particularly, to a mobile terminal used for a mobile communication system simultaneously providing multiple services through a wireless traffic channel by implementing an optimal wireless channel connection using a variable rate voice coding vocoder in order to reduce interference.

### BACKGROUND ART

Mobile communication service has a tendency to change from a typical voice call service to a circuit data service and a packet data service.

The data services provided in a mobile communication system are mainly classified into a circuit data service and a packet data service.

In the mobile communication system, the circuit data service is provided through an inter-working function (IWF), and the packet data service is provided through additional equipment such as a packet data service node (PDSN).

Now, a conventional mobile communication system and a mobile terminal used therefor will be described with reference to the accompanying drawings.

FIG. 1 is a block diagram illustrating the conventional mobile communication system for providing a data service.

The conventional mobile communication system comprises quite a few mobile terminals 120, 130 and 140, a base station controller 110, a packet data terminal 150, a data network, a circuit network, and a mobile switch center 160. Each mobile terminal 120, (130, 140) comprises a data processing unit 121 (131, 141) and a vocoder unit 122 (132, 142). The base station controller 110 comprises quite a few mobile terminal data processing units 111, 114, and 117 to provide the multiple services to the corresponding mobile terminals 120, 130, and 140. Each mobile terminal data processing unit 111 (114, 117) has a data processing unit 112 (115, 118) and a vocoder unit 113 (116, 119).

Firstly, a procedure for providing a packet data service to the mobile terminal A 120 will be described.

If the mobile terminal A 120 or the mobile communication system requests the packet data service, the negotiation of service is performed. When the negotiation of service is normally completed, the data processing unit 121 of the mobile terminal A120 is set to receive the packet data service. The data processing unit 112 of the base station controller 110 allows the packet data to communicate between the mobile terminal A 120 and the packet data terminal 150.

In a case, a voice call is set between the mobile terminal B 130 and the mobile terminal C 140. When one of the mobile terminals A and B requests a voice service, the vocoders 116 and 119 of the base station controller 110 set a call path between the mobile terminals A and B to provides the voice service between the mobile terminals A and B.

FIG. 2 is a block diagram illustrating a transmitting unit of the mobile terminal used for the conventional mobile communication system of FIG. 1

The conventional mobile terminals perform the negotiation of data service in response to a request of one of the mobile terminals or the mobile communication system. When the negotiation of service is normally completed, it is determined that the service is a data service or a voice service.

As shown in FIG. 2, a service selecting unit 230 selects a data processing unit 210 or a vocoder unit 220 in accordance with the result of the negotiation of service option. The data processing unit 210 and the vocoder unit 220 operate in an exclusive manner.

FIG. 3 is a block diagram illustrating a receiving unit of the mobile terminal used for the conventional mobile communication system of FIG. 1.

Basically, the conventional mobile terminal exclusively receives the data service or the voice service.

A service distributing unit 330 distributes a frame received by the mobile terminal into voice and packet data. The voice and the packet data are transferred to the data processing unit 310 and the vocoder unit 320, respectively.

In the convention mobile communication system and the conventional mobile terminal, since the voice service and the data service are exclusively provided, it is difficult to meet the user's request for various services and to provide value-added services.

### SUMMARY OF THE INVENTION

The present invention provides a mobile terminal used for a mobile communication system simultaneously providing multiple services including a voice service and many kinds of services by multiplexing the multiple services through a single wireless traffic channel capable of providing various value-added services.

The present invention also provides a method of providing multiple services between mobile terminals through a wireless traffic channel.

According to an aspect of the present invention, there is provided a mobile terminal used for a mobile communication system simultaneously providing multiple services through a wireless traffic channel, the mobile terminal comprising: a vocoder unit, which vocodes voice with a variable rate; a multiplexing/de-multiplexing unit, which multiplexes or de-multiplexes at least one service of a voice service, a text services, and an image services; at least one CMS (concurrent multiple service) processing unit, which framed a message corresponding to the service and processes to-be-multiplexed transmitted data and de-multiplexed received data; and a wireless modem unit, which transmits the framed message to a counterpart mobile, and forms a multiplexed frame in a wireless matched format, and transmits and receives the multiplexed frame through a mobile communication network.

In the mobile terminal, the multiplexing/de-multiplexing unit may comprise: a CMS transmitting unit, which multiplexes the CMS data transferred by the CMS processing unit and a voice frame having a variable rate; and a CMS receiving unit, which de-multiplexes a frame transferred by the wireless modem unit to extract the CMS data.

In the mobile terminal, the CMS transmitting unit may comprise: memory, which stores the CMS data; a voice frame inspecting unit, which inspects a state of the voice frame transferred by the vocoder unit; and a frame generating unit, which multiplexes the voice frame and the CMS data to generate a single frame in accordance with the inspection result of the voice frame inspecting unit. In addition, in the mobile terminal, the frame generating unit may generate the single frame including the CMS data when the variable rate of the voice frame transferred by the vocoder unit is not a full rate.

In the mobile terminal, the CMS receiving unit may comprise: a CMS data checking/detecting unit, which checks whether or not the CMS data is included into a frame transferred by the wireless modem unit and detects the CMS data; and a memory, which stores the CMS detected by the CMS data checking/detecting unit.

In the mobile terminal, the CMS processing unit may comprise: a transmitting/receiving interfacing unit, which matches the mobile terminal with an external CMS data terminal; and a CMS managing unit, which converts the CMS data transferred by the transmitting/receiving interfacing unit into a multiplexable CMS data to transfer the multiplexable CMS data to the multiplexing/de-multiplexing unit, or converts the CMS data stored in the multiplexing/de-multiplexing unit into a user-checkable CMS data to transfer the user-checkable CMS data to the transmitting/receiving interfacing unit.

In the mobile terminal, the CMS managing unit may comprise: a data segmenting unit, which segments the CMS data transferred by the transmitting/receiving interfacing unit into a good many multiplexable CMS data segments and transfers the good many multiplexable CMS data segments to the data transferring unit; a data transferring unit, which outputs the segmented CMS data segments with a predetermined time period to the multiplexing/de-multiplexing unit, or fetches and outputs the CMS data stored in the multiplexing/de-multiplexing with a predetermined time period; and a data assembling unit, which assembles the CMS data transferred by the data transferring unit. In addition, in the mobile terminal, the data segmenting unit and the data assembling unit may further comprise their own buffers for temporarily storing the segmented or assembled CMS data. In addition, in the mobile terminal, the predetermined time period may be equal to a frame transmitting period of the wireless traffic channel.

In the mobile terminal, the service may include at least one of a name card serve, an image service, and a file transfer service.

According to another aspect of the present invention, there is provided a method of multiplexing/de-multiplexing multiple services to provide the multiple services through a wireless traffic channel, the method comprising steps of: segmenting CMS data transferred by an external CMS data terminal into multiplexable size CMS data segments; inspecting a variable rate of a voice frame transferred by a vocoder unit and determining whether or not the segmented CMS data can be included into a single frame; assembling the segmented CMS data and the voice frame to generate the single frame in accordance with the determination result and transferring the single frame to a wireless modem unit.

According to still another aspect of the present invention, there is provided a method of multiplexing/de-multiplexing multiple services to provide the multiple services through a wireless traffic channel, the method comprising steps of: extracting CMS data from a frame transferred by a wireless modem unit and storing the extracted CMS data; fetching the stored CMS data with a predetermined time period and assembling the CMS data; and transferring the multiplexed CMS data to an external CMS data terminal through a transmitting/receiving interfacing unit.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram illustrating a convention mobile communication system for providing a data service;

FIG. 2 is a block diagram illustrating a transmitting unit of a mobile terminal used for the conventional mobile communication system of FIG. 1;

FIG. 3 is a block diagram illustrating a receiving unit of a mobile terminal used for the conventional mobile communication system of FIG. 1;

FIG. 4 is a block diagram illustrating a mobile communication system for providing a data service according to an embodiment of the present invention;

FIG. 5 is a block diagram illustrating a mobile terminal used for the mobile communication system of FIG. 4;

FIG. 6 is a detailed block diagram illustrating a CMS processing unit of the mobile terminal according to the embodiment of the present invention; and

FIG. 7 is a detailed block diagram illustrating a multiplexing/de-multiplexing unit of the mobile terminal according to the embodiment of the present invention.

### BEST MODE FOR CARRYING OUT THE INVENTION

Now, a mobile terminal used for a mobile communication system providing multiple services through a single wireless traffic channel and a method thereof will be described with reference to the accompanying drawings.

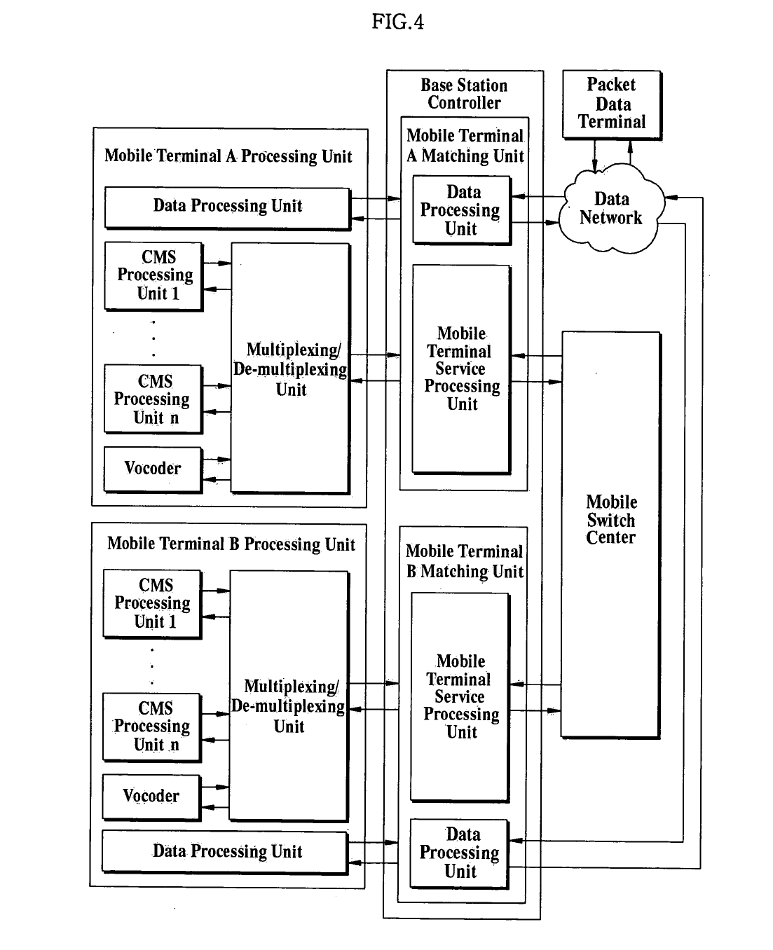

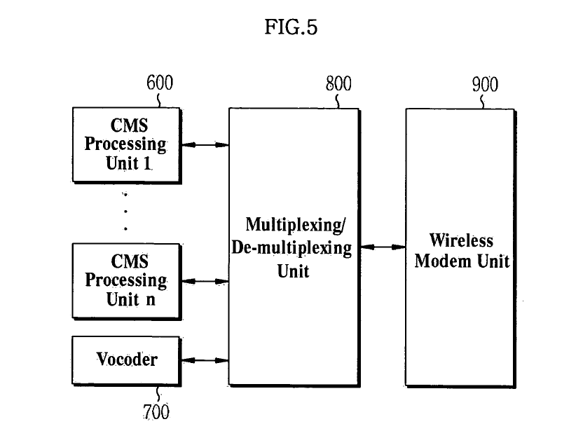

FIG. 4 is a block diagram illustrating a mobile communication system for providing a data service according to an embodiment of the present invention.

The mobile communication system according to the embodiment of the present invention comprises quite a few mobile terminals, a base station controller, a packet data terminal, a data network, and a mobile switch center. The mobile communication system including a control unit provides multiple services to mobile terminals to implement communication between the mobile terminals. Hereinafter, a mobile terminal includes an terminal having a function of the mobile terminal.

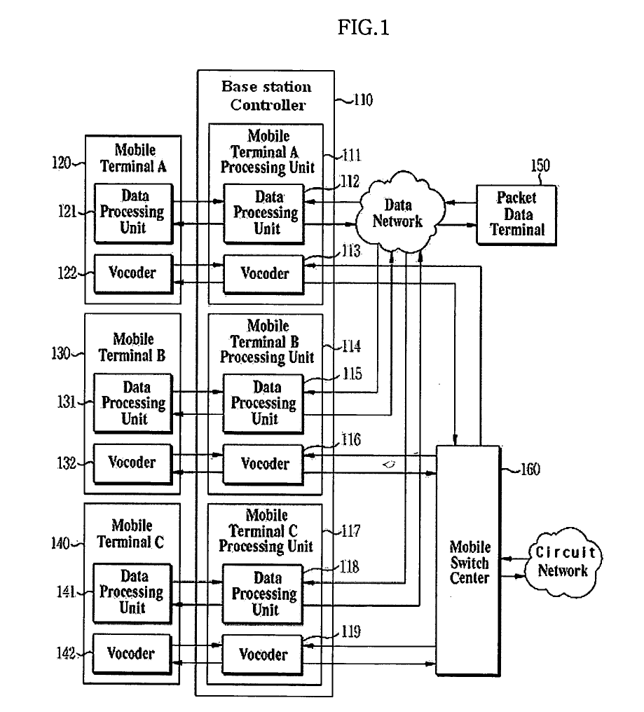

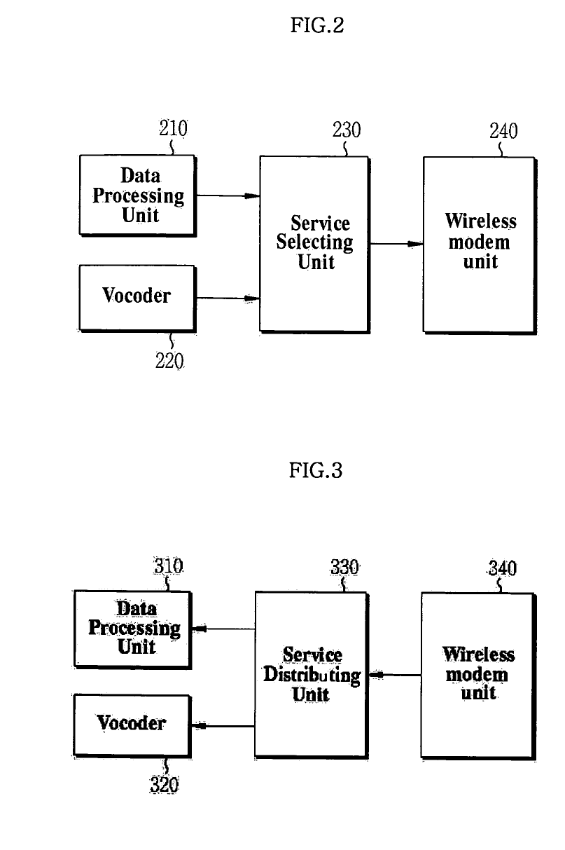

Since the base station controller according to the embodiment has the same construction as the conventional one of FIG. 1, its detailed description is omitted.

FIG. 5 is a block diagram illustrating the mobile terminal used for the mobile communication system of FIG. 4

As shown in FIG. 5, the mobile terminal comprises many kinds of concurrent multiple service (CMS) processing units 600, a vocoder unit 700, a multiplexing/de-multiplexing unit 800, and wireless modem unit 900. The CMS service includes text, name card, still image, moving image, emoticon (emotional icon) services, and so on. The CMS data is stored in an external CMS data terminal or memory of a mobile terminal.

When the mobile terminal transmits the CMS data during a voice call, each of the CMS processing units 600 transfer the CMS data to the multiplexing/de-multiplexing unit 800. On the other hand, when the mobile terminal receives the CMS data during a voice call, the multiplexing/de-multiplexing unit 800 separates the CMS data from the voice frame and the CMS processing units process the CMS data.

The vocoder unit 700 vocodes the voice with a variable rate. For example, when the user speaks, the voice is vocoded with a full rate; when the user does not speak, the voice is vocoded with a ⅛ rate.

When the mobile terminal transmits the CMS data during a voice call, the multiplexing/de-multiplexing unit 800 multiplexes the voice frame of vocoder unit 700 and the CMS data of the CMS processing unit 600 to generate a single frame and transfers the frame to the wireless modem unit 900. On the other hand, when the mobile terminal receives the CMS data during a voice call, the wireless modem unit 900 receives a frame having the voice frame and the CMS data and the multiplexing/de-multiplexing unit 800 de-multiplexes the frame to distribute the voice frame and the CMS data to the vocoder unit 700 and the CMS processing unit 600, respectively.

The wireless modem unit 900 has a function of wireless interfacing in order to transmit a frame transferred by the multiplexing/de-multiplexing unit 800 to a mobile communication network or to receive a frame from the mobile communication network to transfer the frame to the multiplexing/de-multiplexing unit 800.

According to the aforementioned construction, when the mobile terminal transmits the CMS data stored in the memory of the mobile terminal or the external CMS data terminal connected to the mobile terminal, the CMS processing unit 600 processes the CMS data and transfers the CMS data to the multiplexing/de-multiplexing unit 800. The multiplexing/de-multiplexing unit 800 multiplexes the CMS data and a voice frame output from the vocoder unit 700 to generate a single frame and transfers the single frame to the wireless modem unit 900.

On the other hand, when the mobile terminal receives a frame having a voice frame and the CMS data, the multiplexing/de-multiplexing unit 800 de-multiplexes the frame into the voice frame and the CMS data to distribute the voice frame and CMS data to the vocoder 700 and the CMS processing unit 600, respectively. The CMS data processed by the CMS processing unit 600 is represented to the user.

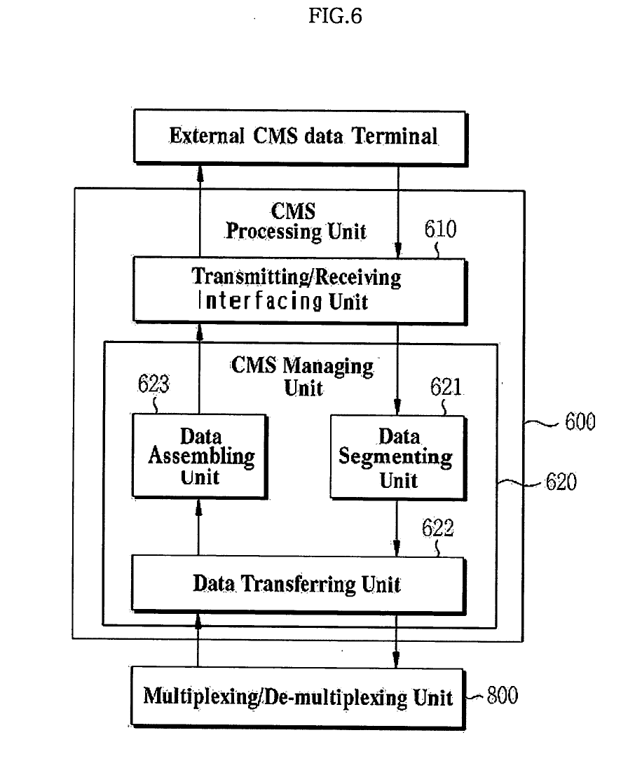

FIG. 6 is a detailed block diagram illustrating the CMS processing unit 600 of the mobile terminal shown in FIG. 5 according to the embodiment of the present invention.

As shown in FIG. 6, the CMS processing unit 600 comprises a transmitting/receiving interfacing unit 610 and a CMS managing unit 620.

The transmitting/receiving interfacing unit 610 has a function of interfacing the mobile terminal with the external CMS data terminal. As described above, the external CMS data terminal is capable of providing the CMS data such as text, name card, still image, moving image data, and so on.

The CMS managing unit 620 converts the CMS data transferred by the transmitting/receiving interfacing unit 610 into a multiplexable CMS data to transfer the multiplexable CMS data to the multiplexing/de-multiplexing unit 800. On the other hand, the CMS managing unit 620 converts the CMS data stored in the multiplexing/de-multiplexing unit 800 into a user-checkable CMS data to transfer the user-checkable CMS data to the transmitting/receiving interfacing unit 610. The CMS data output from the transmitting/receiving interfacing unit 610 are represented to and checked by the user.

More specifically, the CMS managing unit 620 comprises a data segmenting unit 621, a data transferring unit 622, and a data assembling unit 623.

The data segmenting unit 621 segments the CMS data transferred by the transmitting/receiving interfacing unit 610 into a good many multiplexable CMS data segments and transfers the good many multiplexable CMS data segments to the data transferring unit 622. The data transferring unit 620 outputs the multiplexable CMS data segments with a predetermined time period to the multiplexing/de-multiplexing unit 800. On the other hand, the data transferring unit 620 fetches and outputs the de-multiplexed CMS data from the memory with a predetermined time period. The predetermined time period is variable, and preferably, equal to a frame transmitting period of the wireless traffic channel. On the other hand, the data assembling unit 623 assembles the CMS data transferred by the data transferring unit 622 to form a user-checkable CMS data and outputs the user-checkable CMS data to the transmitting/receiving interfacing unit 610.

The data segmenting unit 621 and the data assembling unit 623 may further comprise their own buffers for temporarily storing the segmented or assembled CMS data before transferring the CMS data to the transmitting/receiving interfacing unit 610 or the data transferring unit 622.

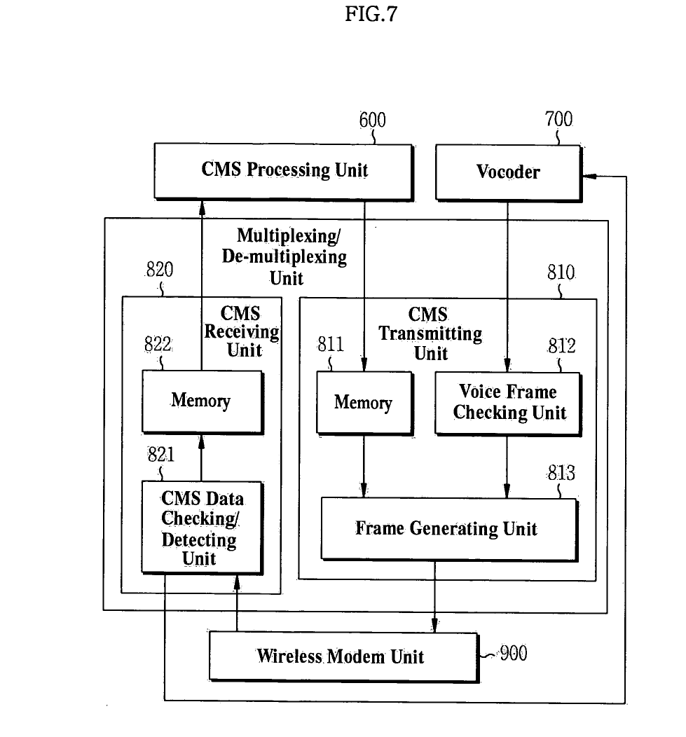

FIG. 7 is a detailed block diagram illustrating the multiplexing/de-multiplexing unit 800 of the mobile terminal shown in FIG. 5 according to the embodiment of the present invention.

As shown in FIG. 7, the multiplexing/de-multiplexing unit 800 comprises a CMS transmitting unit 810 and a CMS receiving unit 810. The CMS transmitting unit 810 multiplexes the CMS data of the CMS processing unit 600 and the voice frame of the vocoder unit 700 to output the multiplexed data td the wireless modem unit 900. Herein, the voice frame has a variable rate. The CMS receiving unit 810 de-multiplexes a frame having the voice frame and the CMS data transferred by the wireless modem unit 900 to extract and store the voice frame and CMS data.

More specifically, the CMS transmitting unit 810 comprises a storage unit 811, a voice frame inspecting unit 812, and a frame generating unit 813. The storage unit 811 temporarily stores the segmented CMS data transferred by the CMS processing unit 600. The voice frame inspecting unit 812 inspects the variable rate of the voice frame in order to determine whether or not the segmented CMS data can be included in to a single frame. In response to the result of the voice frame inspecting unit 812, the frame generating unit 813 multiplexes the voice frame output from the vocoder unit 700 and the CMS data stored in the storage unit 811 to generate a single frame, and outputs the single frame to the wireless modem unit 900. If the variable rate of the voice frame output from the vocoder unit 700 is not a full rate, the frame generating unit 813 multiplexes the voice frame and the segmented CMS data to generate a single frame. If the variable rate of the voice frame output from the vocoder unit 700 is a ⅛ rate, the frame generating unit 813 preferably multiplexes the voice frame and the CMS data to generate a single frame.

The CMS receiving unit 820 comprises a CMS data checking/detecting unit 821 and a storage unit 822. The CMS data checking/detecting unit 821 checks whether or not the voice frame transferred by the wireless modem unit 900 includes CMS data. If the voice frame includes the CMS data, the CMS data checking/detecting unit 821 de-multiplexes the voice frame and detects the CMS data. The memory has a function of a buffer for temporarily storing the CMS data detected by the CMS data checking/detecting unit 821.

Now, the detailed example of the mobile terminal according to the present invention will be described.

Firstly, a case where various service data is transmitted will be described.

The external CMS data terminal providing the various service data inputs the CMS data to the CMS processing unit 600. The CMS data is transferred through the transmitting/receiving interfacing unit 610 to the CMS managing unit 620. On the other hand, the CMS data stored in an memory of the mobile terminal may be fetched and transferred to the CMS managing unit 620 with the user's operating key pads.

The data segmenting unit 621 of the CMS managing unit 620 segments the service data into a good many data segments having such a predetermined size that the data segments can constitute a single frame having a voice frame. Then, the CMS managing unit 620 stores the data segments, that is, the segmented CMS data, in a memory. The voice frame is output to the vocoder unit 700.

The data transferring unit 622 of the CMS managing unit 629 fetches the segmented CMS data stored in the memory of the data segmenting unit 621 with a predetermined time period to transfer the segmented CMS data to the multiplexing/de-multiplexing unit 800. The transferred CMS data is stored in the memory of the multiplexing/de-multiplexing unit 800.

The voice frame inspecting unit 812 of the multiplexing/de-multiplexing unit 800 inspects the variable rate of the voice frame and outputs the result of the inspection. Only if the variable rate of the voice frame is not a full rate, the CMS data and the voice frame can constitute a single frame. Therefore, the inspection has to be performed.

In accordance with the variable rate of the voice frame, the frame generating unit 813 multiplexes the voice frame output from the vocoder unit 700 and the CMS data stored in the storage unit 811 to generate a single frame, and outputs the single frame to the wireless modem unit 900. The most preferable variable rate of the voice frame is ⅛ rate.

If the variable rate of the voice frame output from the vocoder unit 700 is not a full rate, a single frame is reconstructed with a full rate to include the various service data, that is, the CMS data, and the voice frame and the single frame is transmitted via the network. The single frame including the CMS data and the voice frame is considered to be a conventional voice frame in wireless regions and system regions, for example, base stations and switches. On the other hand, the single frame including the CMS data and the voice frame is considered to be CMS data in the mobile terminals. Therefore, it is possible to communicate the CMS data during a voice call.

Next, a case where various service data is received will be described.

The voice frame transmitted through a wireless traffic channel is received by the mobile terminal. The voice frame is input to the wireless modem unit 900 and transferred to the multiplexing/de-multiplexing unit 800. The CMS data checking/detecting unit 821 of the multiplexing/de-multiplexing unit 800 checks whether or not the received voice frame includes CMS data. If the voice frame includes the CMS data, the CMS data checking/detecting unit 821 de-multiplexes the received voice frame to separate the CMS data from the voice frame and extract and distribute the CMS data and the voice frame to the CMS processing unit 600 and the vocoder unit 700. The CMS data extracted by the CMS data checking/detecting unit 821 is temporarily stored in the memory 822.

After the CMS data is stored in the memory 822, the data transferring unit 622 of the CMS processing unit 600 fetches the CMS data from the memory 822 with a predetermined time period to outputs the CMS data to the data assembling unit 623. The data assembling unit 623 assembles the CMS data into user-checkable CMS data.

The assembled CMS data is transferred through the transmitting/receiving interfacing unit 610 to the external CMS data terminal. The user can check the CMS data by using the external CMS data terminal. On the other hand, the assembled CMS data may be stored in the memory of the mobile terminal. The user may display and check the CMS data with operating key pads of the mobile terminal.

In a mobile communication system having a function of messenger, a messenger unit is connected to a mobile terminal having a CMS function. The messenger unit interfacing with the mobile terminal encapsulates a message and information about a receiver to generate a single message, and transmits the single message to a server. The server transfers a plurality of the single messages to the respective receivers by interfacing with an SMS center. Therefore, it is possible to transmit the plurality of messages to the plurality of the receivers with only one wireless channel connection irrespective of the number of the receivers.

In a conventional approach, 1,000 times of channel connections have to be made in order to transmits 1,000 messages to 1,000 clients. However, according to the present invention, it is possible to transmit 1,000 messages to 1,000 clients with only a single up-link channel connection.

### INDUSTRIAL AVAILABILITY

According to the present invention, since multiple services are simultaneously transmitted or received, it is possible to easily provide value-added services. In addition, since a single frame comprising various service data can be optimally transmitted or received, it is possible to effectively use a wireless network. In addition, since various value-added services can be provided between mobile terminals through a mobile communication network without limitation, it is possible to inexpensively provide various value-added services together with a voice service.

In addition, since a mobile terminal can send a large number of wireless messages to a plurality of receivers with only one wireless channel connection irrespective of the number of receivers, it is possible to efficiently reduce load of the wireless network and to implement the same degree of security as a messenger method using the wireless network.

In addition, since a mobile terminal can send a single message to a plurality of receivers with only one wireless channel connection irrespective of the number of receivers, it is possible to efficiently reduce data amount in an up-link channel connection.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A mobile terminal used for a mobile communication system simultaneously providing multiple services through a wireless traffic channel, the mobile terminal comprising:
a vocoder unit, which vocodes voice data with a variable rate;
a multiplexing/de-multiplexing unit, which multiplexes or de-multiplexes at least one service of a voice service, a text services, and an image services;
at least one CMS (concurrent multiple service) processing unit, which segments a message corresponding to the service and processes to-be-multiplexed transmitted data and de-multiplexed received data; and
a wireless modem unit, which transmits the framed message to a counterpart mobile terminal through a up-link wireless connection, and forms a multiplexed frame in a wireless matched format, and transmits and receives the multiplexed frame through a mobile communication network.

2. The mobile terminal according to claim 1, wherein the multiplexing/de-multiplexing unit comprises:
a CMS transmitting unit, which multiplexes the CMS data transferred by the CMS processing unit and a voice frame having a variable rate; and
a CMS receiving unit, which de-multiplexes a frame transferred by the wireless modem unit to extract the CMS data.

3. The mobile terminal according to claim 2, wherein the CMS transmitting unit comprises:
a memory, which stores the CMS data transferred by the CMS processing unit;
a voice frame inspecting unit, which inspects a state of the voice frame transferred by the vocoder unit; and
a frame generating unit, which multiplexes the voice frame and the CMS data to generate a single frame in accordance with the inspection result of the voice frame inspecting unit.

4. The mobile terminal according to claim 3, wherein the frame generating unit generates the single frame including the CMS data when the variable rate of the voice frame transferred by the vocoder unit is not a full rate.

5. The mobile terminal according to claim 2, wherein the CMS receiving unit comprises:
a CMS data checking/detecting unit, which checks whether or not the CMS data is included into a frame transferred by the wireless modem unit and detects the CMS data; and
a memory, which stores the CMS data detected by the CMS data checking/detecting unit.

6. The mobile terminal according to claim 1, wherein the CMS processing unit comprises:
a transmitting/receiving interfacing unit, which matches the mobile terminal with an external CMS data terminal; and
a CMS managing unit, which converts the CMS data transferred by the transmitting/receiving interfacing unit into a multiplexable CMS data to transfer the multiplexable CMS data to the multiplexing/de-multiplexing unit, or converts the CMS data stored in the multiplexing/de-multiplexing unit into a user-checkable CMS data to transfer the user-checkable CMS data to the transmitting/receiving interfacing unit.

7. The mobile terminal according to claim 6, wherein the CMS managing unit comprises:
a data segmenting unit, which segments the CMS data transferred by the transmitting/receiving interfacing unit into a good many multiplexable CMS data segments;
a data transferring unit, which outputs the segmented CMS data segments with a predetermined time period to the multiplexing/de-multiplexing unit, or fetches and outputs the CMS data stored in the multiplexing/de-multiplexing unit with a predetermined time period; and
a data assembling unit, which assembles the CMS data transferred by the data transferring unit.

8. The mobile terminal according to claim 7, wherein the data segmenting unit and the data assembling unit further comprise their own memory for temporarily storing the segmented or assembled CMS data.

9. The mobile terminal according to claim 7, wherein the predetermined time period is equal to a frame transmitting period of the wireless traffic channel.

10. The mobile terminal according to claim 1, wherein the service includes at least one of a name card serve, an image service, and a file transfer service.

11. A method of multiplexing/de-multiplexing multiple services to simultaneously provide the multiple services through a wireless traffic channel, the method comprising steps of:
segmenting CMS data transferred by an external CMS data terminal into multiplexable size CMS data segments;
inspecting a variable rate of a voice frame transferred by a vocoder unit and determining whether or not the segmented CMS data can be included into a single frame;
multiplexing the segmented CMS data and the voice frame to generate the single frame in accordance with the determination result and transferring the single frame to a wireless modem unit.

12. A method of multiplexing/de-multiplexing multiple services to simultaneously provide the multiple services through a wireless traffic channel, the method comprising steps of:
extracting CMS data from a frame transferred by a wireless modem unit and storing the extracted CMS data;
fetching the stored CMS data with a predetermined time period and assembling the CMS data; and
transferring the assembled CMS data to an external CMS data terminal through a transmitting/receiving interfacing unit.
